(19) United States
(12) Patent Application Publication
(10) Pub. No.: US 2024/0204316 A1
(43) Pub. Date: Jun. 20, 2024

(54) HIGH VOLTAGE BATTERY WITH BATTERY HOUSING

(71) Applicant: MAGNA STEYR Fahrzeugtechnik GmbH & Co KG, Graz (AT)

(72) Inventor: Jiri NOVOTNY, Muenchen (DE)

(73) Assignee: MAGNA STEYR Fahrzeugtechnik GmbH & Co KG, Graz (AT)

(21) Appl. No.: 18/528,019

(22) Filed: Dec. 4, 2023

(30) Foreign Application Priority Data
Dec. 15, 2022 (EP) 22213731.7
Nov. 9, 2023 (EP) 23208811.2

(51) Int. Cl. H01M 50/209; B60L 50/64; H01M 50/224; H01M 50/233; H01M 50/271

(52) U.S. Cl. CPC H01M 50/209; B60L 50/64; H01M 50/224; H01M 50/233; H01M 50/271; H01M 2220/20

(57) ABSTRACT

A high-voltage battery for a motor vehicle, and a motor vehicle having such a high-voltage battery. The high-voltage battery includes a battery housing including a housing cover and at least one housing base having one or more conjoined double-crosspiece panels, each crosspiece panel in the double-crosspiece panel formed by two flat panels oriented parallel to one another, and a plurality of crosspieces arranged substantially parallel to one another at substantially regular intervals in order to connect the crosspiece panels; and battery cells arranged in the battery housing between the housing base and the housing cover.

### CROSS-REFERENCE TO RELATED APPLICATIONS

The present application claims priority 35 U.S.C. § 119 to European Patent Publication No. EP 22213731.7 (filed on Dec. 15, 2022) and European Patent Publication No. EP 23208811.2 (filed on Nov. 9, 2023), which are each hereby incorporated by reference in their complete entireties.

### TECHNICAL FIELD

One or more embodiments of the present disclosure relates to a high-voltage battery for a motor vehicle.

### BACKGROUND

High-voltage batteries for motor vehicles are increasingly being used nowadays as traction batteries for electric vehicles and hybrid vehicles. The high-voltage batteries typically comprise a plurality of battery cells which are arranged in a battery housing.

Battery housings that are customary today for high-voltage batteries are highly complex and consist of numerous components which have to be matched to one another very precisely. As a result, the design of the interior space of the battery housing is inflexible, because the cell blocks, fastenings and reinforcing structures also have to be optimized for the expected loads and desired rigidity values. Components in the housing often perform only a single function. All this results in a high weight of the high-voltage battery, and diminishes the space available for the cells.

### SUMMARY

One or more embodiments of the present disclosure provides a high-voltage battery for a motor vehicle that can be easily and flexibly adapted to differing requirements. The high-voltage battery is to satisfy stringent requirements in terms of mechanical strength, and at the same time is to have low weight. In addition, the high-voltage battery is to have a large interior space for battery cells, and is consequently to have a high capacity.

In accordance with the one or more embodiments, a high-voltage battery for a motor vehicle comprises one or more of the following: a battery housing that includes a housing cover and at least one housing base having one or more conjoined (i.e., joined together) double-crosspiece panels formed of aluminum, each crosspiece panel in the double-crosspiece panel formed by two flat panels oriented parallel to one another, and a plurality of crosspieces arranged substantially parallel to one another at substantially regular intervals in order to connect the crosspiece panels; and battery cells arranged in the battery housing between the housing base and the housing cover.

In accordance with the one or more embodiments, one or more double-crosspiece panels are consequently employed as a base for a battery housing. The crosspiece-panel base offers a rigid structure for accommodating the battery cells, and as a result also offers enhanced mechanical strength and protection, for instance, in the course of a bollard crossing. By virtue of the configuration of the crosspiece panel, these functions are individually adjustable in straightforward manner, whereby savings of weight and construction space are also made, since no additional components are necessary. The rigidity and the bollard-crossing protection can be adjusted, in particular, by the height of the crosspiece-panel arrangement and also by the wall thickness and/or the number of crosspieces between the crosspiece panels.

In accordance with the one or more embodiments, the technical solution of using the double-crosspiece-panel base is consequently flexible and easily adjustable. The core component of the battery housing is the base, which comprises one or more joined double-crosspiece panels formed of aluminum. The double-crosspiece-panel base enables high flexibility, a weight-efficient, and space-efficient design of the battery housing. The double-crosspiece-panel base can perform several functions at the same time; in particular, it can make degassing chambers available, it can form an underride protection and/or a reinforcement, for instance, for a side impact. The double-crosspiece-panel base already has high inherent rigidity, which can be increased by supplementing with additional reinforcements if necessary. The load-bearing component is the double-crosspiece-panel base, and the optional internal reinforcements complement the rigidity of the base. The housing base, comprising double-crosspiece panels, offers high flexibility of the design of the battery housing, since internal reinforcing structures in the housing can be distinctly reduced or may be dispensed with completely. As a result, more space arises for cells which can also be made more flexible.

As used herein, the term “plurality” for the crosspieces means that at least three crosspieces have to be present, so that there can be “regular intervals” between the crosspieces. In accordance with the one or more embodiments, however, there can be preferably at least 5, at least 10, and particularly preferably at least 20 crosspieces that connect the two panels to one another.

In accordance with the one or more embodiments, two opposing sidewalls of the battery housing are preferentially constituted by transverse members of the motor vehicle, in particular, by sidewalls of the battery housing situated at the front and at the rear in the installed position in the motor vehicle.

In accordance with the one or more embodiments, two lateral boundaries, parallel to one another, of the housing base are preferably constituted by longitudinal members of the motor vehicle. At least the base, optionally also the entire height of the battery housing, may be bounded by longitudinal members of the motor vehicle, in particular by sidewalls of the battery housing and/or of the battery housing situated on the left and on the right in the installed position in the motor vehicle.

In accordance with the one or more embodiments, a plurality of stiffening slats and/or stiffening domes and/or connecting elements are preferentially arranged between the housing base and the housing cover and are fastened to the housing base and to the housing cover. Stiffening slats may be substantially planar components which extend from the housing base to the housing cover. They may have been arranged parallel to one another. They may extend in the Y-direction of the motor vehicle and/or may extend in the same direction as the crosspieces of the housing base. Alternatively or additionally to the planar stiffening slats, substantially columnar stiffening domes may also have been arranged for the purpose of stiffening between the housing base and the housing cover. For instance, within stiffening slats and/or stiffening domes, or even separated from them, connecting elements, for instance in the manner of screwed joints, may have been inserted between the housing base and the housing cover.

In accordance with the one or more embodiments, cover-reinforcing slats may have been arranged on the housing cover, in particular on the outside of the housing cover, in order to stiffen the housing cover, particularly if the latter is serving as the floor of the motor vehicle body. The cover-reinforcing slats have preferably been arranged parallel to the stiffening slats and/or at positions that at least partially overlap with the positions of the stiffening slats.

In accordance with the one or more embodiments, at least some of the crosspieces, preferably all of the crosspieces in at least one surface region of the double-crosspiece panel, have preferably been designed in such a way that there are free spaces between the crosspiece and the panel that is located on the side of the housing base facing towards the battery cells, this panel exhibiting openings so that a degassing of the battery cells can take place through the housing base via the openings in the panel and the free spaces between the panel and the crosspiece. The free spaces may preferably have been formed by virtue of the fact that the crosspieces do not extend over the entire height between the panels of the housing base. A degassing can take place through the free spaces or cavities in the crosspiece-panel base. Since the degassing takes place through the cavities in the crosspiece-panel base, the battery cells may have been arranged closer to the base or may even be located on top of it, i.e., they may be in contact with the housing base. A spacing between cells and base is not required. The available construction space can consequently be utilized better.

In accordance with the one or more embodiments, an opening in the panel that is located on the side of the housing base facing towards the battery cells has preferably been assigned in each instance to a free space between the crosspiece and this panel. There are consequently as many free spaces as there are openings in the upper panel in the installed position.

In accordance with the one or more embodiments, at least one surface region of the double-crosspiece panel may have been designed differently from at least one other surface region of the double-crosspiece panel, in particular by virtue of the fact that in certain regions the crosspieces of the double-crosspiece panel have a different density and/or a different shape and/or a different height.

In accordance with the one or more embodiments, a motor vehicle comprises: a pair of sills; a high-voltage battery arranged between two sills, the high-voltage battery including a battery housing that includes a housing cover and at least one housing base having one or more conjoined (i.e., joined together) double-crosspiece panels formed of aluminum, each crosspiece panel in the double-crosspiece panel formed by two flat panels oriented parallel to one another, and a plurality of crosspieces arranged substantially parallel to one another at substantially regular intervals in order to connect the crosspiece panels; and battery cells arranged in the battery housing between the housing base and the housing cover.

In accordance with the one or more embodiments, the sills are preferably arranged above the longitudinal members and laterally alongside the battery housing.

In accordance with the one or more embodiments, the crosspieces and/or the stiffening slats and/or the cover-reinforcing slats preferentially extend in the Y-direction of the motor vehicle.

### DRAWINGS

One or more embodiments of the present disclosure will be illustrated by way of example in the drawings and explained in the description hereinbelow.

FIG. 1 illustrates a schematic side view of a housing base of a high-voltage battery, in accordance with one or more embodiments.

FIG. 2 illustrates a schematic side view of an alternative embodiment of a housing base of a high-voltage battery, in accordance with one or more embodiments.

FIG. 3 illustrates a perspective view of a high-voltage battery, in accordance with one or more embodiments.

FIG. 4 illustrates a schematic side view of a high-voltage battery without battery cells, in accordance with one or more embodiments.

FIG. 5 illustrates a front view of another alternative embodiment of a housing base of a high-voltage battery, in accordance with one or more embodiments.

FIG. 6 illustrates a perspective view of the housing base of FIG. 5.

### DESCRIPTION

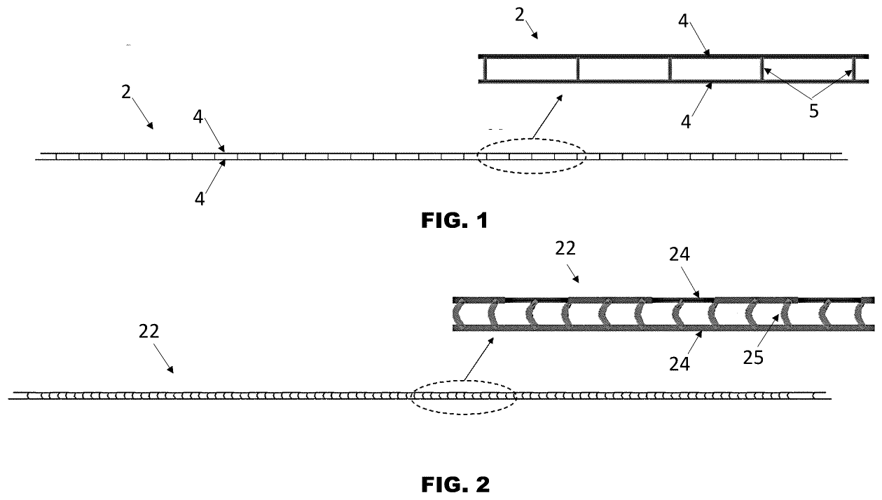

FIG. 1 illustrates a housing base 2 of a high-voltage battery in accordance with one or more embodiments. At the top right, a detail of the housing base 2 is represented on an enlarged scale. The housing base 2 comprises one or more joined-together double-crosspiece panels formed of aluminum. Each double-crosspiece panel comprises two flat panels 4 oriented parallel to one another, and a plurality of crosspieces 5 arranged parallel to one another at regular intervals in order to connect the two panels 4.

FIG. 2 illustrates an alternative embodiment of a housing base 22 having a different surface region of the double-crosspiece than FIG. 1, or a different embodiment of a double-crosspiece panel. The crosspieces 25 of FIG. 2 have a different structural configuration or design than the crosspieces 5 of FIG. 1. In FIG. 2, the crosspieces 25 have an arch shape. Different shapes, different densities of the crosspieces 5, 25 and/or different heights of the crosspieces 5, 25 from those in a different surface region or in a different double-crosspiece panel are also possible.

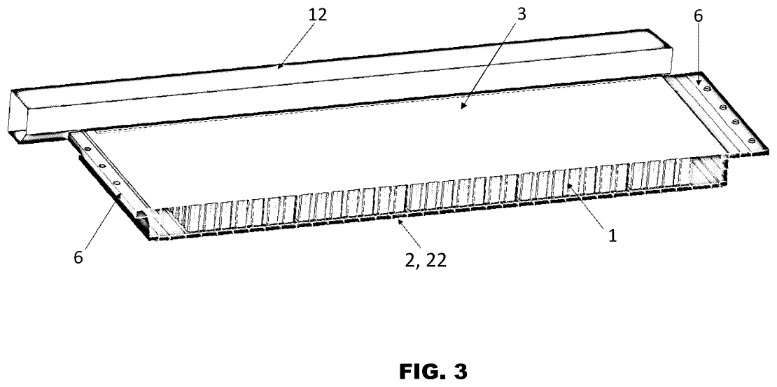

FIG. 3 illustrates a high-voltage battery in accordance with one or more embodiments. The high-voltage battery comprises a plurality of battery cells 1 arranged in the battery housing in a transverse direction, i.e., in the Y-direction of the motor vehicle. The battery housing comprises at least one housing base 2, 22 and a housing cover 3. The battery cells 1 are arranged between the housing base 2, 22 and the housing cover 3.

Two opposing sidewalls of the battery housing are constituted by transverse members 6 of the motor vehicle. These transverse members 6 may be arranged at the front and at the rear of the motor vehicle in the longitudinal direction of the motor vehicle and may extend in the transverse direction of the motor vehicle.

Two lateral boundaries, parallel to one another, of the housing base 2, 22 are constituted by longitudinal members of the motor vehicle. The longitudinal members may constitute left and right boundaries of the housing base 2, 22 and may extend in the longitudinal direction of the motor vehicle.

The battery housing is arranged between two sills 12 of the motor vehicle, of which one sill is represented in FIG. 3. The sills 12 may have been arranged above the longitudinal members and laterally alongside the battery housing.

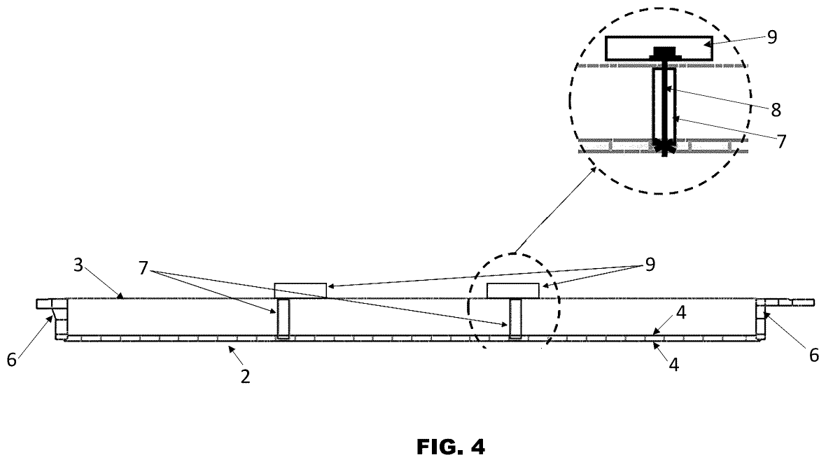

FIG. 4 illustrates a high-voltage battery (the battery cells are not represented). An enlarged representation of a detail is again represented at the top right in FIG. 4. A plurality of substantially surface-forming stiffening slats 7 and/or substantially stud-shaped stiffening domes and/or connecting elements 8, such as screws, are arranged between the housing base 2 and the housing cover 3. The surface-forming stiffening slats 7 and/or substantially stud-shaped stiffening domes and/or connecting elements 8 are fastened to the housing base 2 and the housing cover 3. The connecting elements 8 may be arranged in the stiffening slats 7 and/or stiffening domes, and/or may fasten these to the housing base 2 and to the housing cover 3. A plurality of cover-reinforcing slats 9 are arranged on the housing cover 3, parallel to the stiffening slats 7 and at positions that overlap at least partially with the positions of the stiffening slats 7.

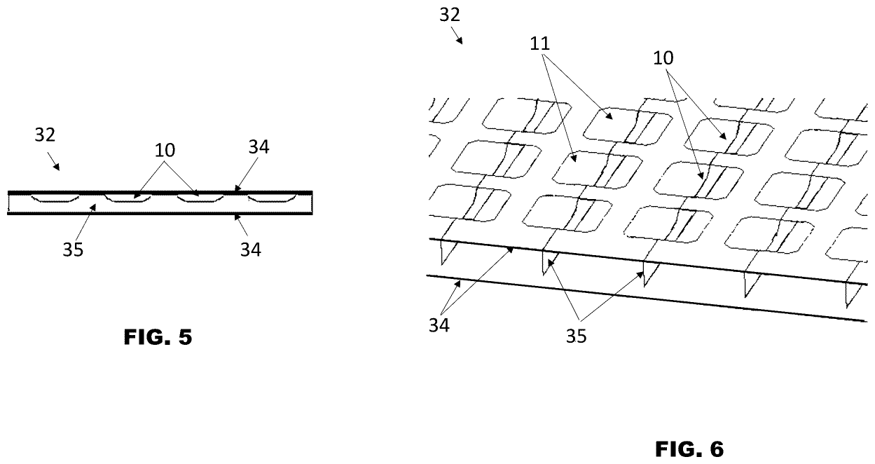

FIGS. 5 and 6 respectively illustrate a housing base in a further embodiment. The crosspieces 35 are formed in at least the illustrated surface region of the double-crosspiece panel in such a way that there are free spaces 10 between the crosspiece 35 and the panel 34, i.e., located on the side of the housing base 32 facing towards the battery cells 1. In essence, the upper panel 34 has openings 11 so that a degassing of the battery cells 1 can take place through the housing base 32 via the openings 11 in the panel 34 and the free spaces 10 between the panel 34 and crosspiece 35. An opening 11 in the panel 34 situated at the top, which is accordingly located on the side of the housing base 32 facing towards the battery cells 1, is assigned to a free space 10 between the crosspiece 35 and the panel 34. In the illustrated embodiment, there are consequently as many openings 11 as there are free spaces 10. The crosspieces 35 and/or the stiffening slats 7 and/or the cover-reinforcing slats 9 extend in the Y-direction of the motor vehicle.

In summary, high-voltage batteries with such a battery housing with a base comprising double-crosspiece panels may have the following advantages.

High flexibility of the design of the battery housing, in particular, with respect to rigidity values and spatial design. The rigidity of the double-crosspiece-panel base can be flexibly adapted, for instance by compaction of ribs, i.e., crosspieces, by increase in wall thickness, the height of the base, the shape of the crosspieces, for example, by virtue of curvature.

High flexibility of the design of the interior space of the battery housing by virtue of the reduced reinforcing structures; consequently weight-efficient and space-efficient design of the housing.

Flexible options for linking to the motor vehicle body.

Flexible option for adaptation to the cells, for example for an effective degassing of the battery cells.

The terms “coupled,” “attached,” or “connected” may be used herein to refer to any type of relationship, direct or indirect, between the components in question, and may apply to electrical, mechanical, fluid, thermal, optical, electromagnetic, electromechanical, or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SYMBOLS

1 battery cells
2, 22, 32 housing base
3 housing cover
4, 24, 34 panel
5, 25, 35 crosspiece
6 transverse member
7 stiffening slat
8 connecting element
9 cover-reinforcing slat
10 free space
11 opening
12 sill

What is claimed is:

1. A high-voltage battery for a motor vehicle, the high-voltage battery comprising:
a battery housing including a housing cover and at least one housing base having one or more conjoined double-crosspiece panels, each crosspiece panel in the double-crosspiece panel formed by two flat panels oriented parallel to one another, and a plurality of crosspieces arranged substantially parallel to one another at substantially regular intervals in order to connect the crosspiece panels; and
battery cells arranged in the battery housing between the housing base and the housing cover.

2. The high-voltage battery of claim 1, wherein two opposing sidewalls of the battery housing are constituted by transverse members of the motor vehicle.

3. The high-voltage battery of claim 1, wherein:
the housing base has two lateral boundaries that are parallel to one another, and
the lateral boundaries are constituted by longitudinal members of the motor vehicle.

4. The high-voltage battery of claim 1, further comprising a plurality of stiffening slats arranged between the housing base and the housing cover and fastened to the housing base and the housing cover.

5. The high-voltage battery of claim 4, further comprising a plurality of stiffening domes arranged between the housing base and the housing cover and fastened to the housing base and the housing cover.

6. The high-voltage battery of claim 5, further comprising a plurality of connecting elements arranged between the housing base and the housing cover and fastened to the housing base and the housing cover.

7. The high-voltage battery of claim 4, further comprising a plurality of cover-reinforcing slats arranged on the housing cover to at least partially overlap with the stiffening slats.

8. The high-voltage battery of claim 1, wherein for each double-crosspiece, the crosspieces define, in at least one surface region of the double-crosspiece panel, free spaces between the crosspieces and the double-crosspiece panel located on a side of the housing base facing the battery cells.

9. The high-voltage battery of claim 8, wherein the double-crosspiece panel located on the side of the housing base facing the battery cells comprises a plurality of openings to facilitate degassing of the battery cells through the housing base and the free spaces between the double-crosspiece panel and the crosspiece.

10. The high-voltage battery of claim 9, wherein each opening is assigned to a corresponding one of the free spaces arranged between the crosspiece and the double-crosspiece panel located on the side of the housing base facing the battery cells.

11. The high-voltage battery of claim 1, wherein at least one surface region of the double-crosspiece panel has a different structural configuration that at least one other surface region of the double-crosspiece panel.

12. The high-voltage battery of claim 1, wherein at least one surface region of the double-crosspiece panel has a different a different density and/or shape and/or height that at least one other surface region of the double-crosspiece panel.

13. The high-voltage battery of claim 1, wherein the double-crosspiece panels are formed of aluminum.

14. A motor vehicle, comprising:
a pair of sills spaced apart from each other;
a high-voltage battery that includes:
a battery housing arranged between the sills in a manner such that the sills are arranged above and laterally adjacent to the battery housing, the battery housing including a housing cover and at least one housing base having one or more conjoined double-crosspiece panels, each crosspiece panel in the double-crosspiece panel formed by two flat panels oriented parallel to one another, and a plurality of crosspieces arranged substantially parallel to one another at substantially regular intervals in order to connect the crosspiece panels; and
battery cells arranged in the battery housing between the housing base and the housing cover.

15. The motor vehicle of claim 14, further comprising a plurality of stiffening slats arranged between the housing base and the housing cover and fastened to the housing base and the housing cover.

16. The motor vehicle of claim 15, further comprising a plurality of stiffening domes arranged between the housing base and the housing cover and fastened to the housing base and the housing cover.

17. The motor vehicle of claim 16, further comprising a plurality of connecting elements arranged between the housing base and the housing cover and fastened to the housing base and the housing cover.

18. The motor vehicle of claim 15, further comprising a plurality of cover-reinforcing slats arranged on the housing cover to at least partially overlap with the stiffening slats.

19. The motor vehicle of claim 14, wherein the crosspieces and/or the stiffening slats and/or the cover-reinforcing slats extend in a Y-direction of the motor vehicle.

20. The motor vehicle of claim 14, wherein:
for each double-crosspiece, the crosspieces define, in at least one surface region of the double-crosspiece panel, free spaces between the crosspieces and the double-crosspiece panel located on a side of the housing base facing the battery cells,
the double-crosspiece panel located on the side of the housing base facing the battery cells comprises a plurality of openings to facilitate degassing of the battery cells through the housing base and the free spaces between the double-crosspiece panel and the crosspiece, and
each opening is assigned to a corresponding one of the free spaces arranged between the crosspiece and the double-crosspiece panel located on the side of the housing base facing the battery cells.
